(19) United States
(12) Patent Application Publication
(10) Pub. No.: US 2022/0114220 A1
(43) Pub. Date: Apr. 14, 2022

(54) PRIVATE SERVER DETECTION DEVICE AND CONTROL METHOD THEREOF

(71) Applicant: AI SPERA INC., Seoul (KR)

(72) Inventors: Byung Tak KANG, Seoul (KR); Ha Na KIM, Uiwang-si (KR); Sun Hye KIM, Goyang-si (KR)

(73) Assignee: AI SPERA INC., Seoul (KR)

(21) Appl. No.: 17/408,901

(22) Filed: Aug. 23, 2021

(30) Foreign Application Priority Data
Oct. 14, 2020 (KR) 10-2020-0132866

(51) Int. Cl. G06F 16/951; H04L 29/08

(52) U.S. Cl. CPC G06F 16/951; H04L 67/02

(57) ABSTRACT

The present disclosure provides a private server detection method through a computer, the method comprising: checking a banner in a database; determining whether a keyword is included in the banner; accessing a web page corresponding to the banner when the keyword is included; determining whether an operating server of the web page is a private server, based on a meta tag of the web page; generating information related to the operating server by crawling the web page when the operating server is a private server; and adding the generated information to the database, wherein the web page corresponds to an IP address and a port number from which the banner is obtained.

### CROSS-REFERENCE TO RELATED APPLICATION

A claim for priority under 35 U.S.C. § 119 is made to Korean Patent Application No. 10-2020-0132866 filed on Oct. 14, 2020 in the Korean Intellectual Property Office, the entire contents of which are hereby incorporated by reference.

### BACKGROUND

### 1. Technical Field

The present disclosure relates to a private server detection device and a control method thereof, and more particularly, to a private server detection device and a control method thereof for determining whether an operating server is a private server, based on whether it is included in a keyword of a banner.

### 2. Description of Related Art

Recently, with the development of computer and smartphone technologies, various functions can be implemented using computers and smartphones. In addition, as various contents such as games are provided through application programs regardless of location, due to the development of network technology, the number of contents users is increasing worldwide. In addition, the number of online gamers is also increasing.

Online games are mainly played through leveling up a character by performing missions with a user character in an online game. Accordingly, leveling up has become a very important factor in generating interest in games for gamers in an online game.

Recently, as a private server that provides the same game as a server operating an online game has appeared, it has been relatively easy to level up the character a user uses on the private server, as compared to the characters of other gamers who play the game on a public server. Hence, it is more frequent that gamers play games only on a private server.

This phenomenon is also emerging in multi-player games provided online, which are games in which two or more gamers compete or cooperate with each other.

Accordingly, there is an increasing need to detect a private server providing the same game as a server operating an online game.

### SUMMARY

An aspect of the present disclosure is directed to providing a private server detection device and a control method thereof for determining whether an operating server is a private server, based on whether it is included in a keyword of a banner so that gamers can enjoy a game in a fair playing environment.

A private server detection method through a computer according to an embodiment of the present disclosure includes: checking a banner in a database; determining whether a first keyword is included in the banner; accessing a web page corresponding to the banner when the first keyword is included; determining whether an operating server of the web page is a private server, based on a meta tag of the web page; generating information related to the operating server by crawling the web page when the operating server is a private server; and adding the generated information to the database, wherein the web page may correspond to an IP address and a port number from which the banner is obtained.

In addition, the determination of whether the operating sever is a private server according to an embodiment of the present disclosure may include: determining whether a second keyword is included in a second area, other than a first area, including a HTML title and a keyword area in the meta tag; determining whether a third keyword is included in the first area when the second keyword is not included; determining whether the third keyword is included in the first area when the second keyword is included and any one of whitewords and whiteIP is included in the second area; and determining that the operating server is a private server when the second keyword is included and neither whitewords nor whiteIP is included in the second area.

In addition, the determination of whether the third keyword is included in the first area according to an embodiment of the present disclosure may include: determining that the operating server is a public server when the third keyword is not included in the first area; and determining that the operating server is a public server only when the third keyword is included in the first area and any one of the whitewords and whiteIP is included in the first area.

In addition, the banner of the present disclosure may be obtained by requesting the banner from a global IP address and port number.

In addition, the information related to the operating server of the present disclosure may include at least one of a hosting server operating the operating server, a host name, a country code, and a domain address.

A private server detection device according to an embodiment of the present disclosure includes: a communication unit; a memory with a database; and a processor configured to check a banner in the database, to determine whether a first keyword is included in the banner, to access a web page corresponding to the banner through the communication unit when the first keyword is included, to determine whether an operating server of the web page is a private server, based on a meta tag of the web page, to generate information related to the operating server by crawling the web page when the operating server is a private server, and to add the generated information to the database, wherein the web page may correspond to an IP address and a port number from which the banner is obtained.

According to the embodiments of the present disclosure, it is possible to fundamentally prevent damage to gamers using a game provided by a public server by detecting a private server.

### BRIEF DESCRIPTION OF THE DRAWINGS

FIG. 1 is a schematic diagram for collecting banners according to an embodiment of the present disclosure.

FIG. 2 is a block diagram illustrating a private server detection device according to an embodiment of the present disclosure.

FIG. 3 is a diagram illustrating a banner according to an embodiment of the present disclosure.

FIG. 4 is a diagram illustrating a meta tag according to an embodiment of the present disclosure.

FIG. 5 is a flowchart illustrating a method for detecting a private server according to an embodiment of the present disclosure.

FIG. 6 is a flowchart illustrating a method for detecting a private server according to an embodiment of the present disclosure.

### DETAILED DESCRIPTION

The advantages and features of the present disclosure and methods of achieving them will be apparent from the embodiments that will be described in detail with reference to the accompanying drawings. It should be noted, however, that the present disclosure is not limited to the following embodiments, and may be implemented in various different forms. Rather the embodiments are provided so that this disclosure will be thorough and complete and will fully convey the scope of the present disclosure to those skilled in the technical field to which the present disclosure pertains, and the present disclosure will only be defined by the appended claims.

Terms used in the specification are used to describe embodiments of the present disclosure and are not intended to limit the scope of the present disclosure. In the specification, the terms of a singular form may include plural forms unless otherwise specified. The expressions “comprise” and/or “comprising” used herein indicate existence of one or more other elements other than stated elements but do not exclude presence of additional elements. Like reference denotations refer to like elements throughout the specification. As used herein, the term “and/or” includes each and all combinations of one or more of the mentioned elements. It will be understood that, although the terms “first”, “second”, etc., may be used herein to describe various elements, these elements should not be limited by these terms. These terms are only used to distinguish one element from another element. Accordingly, a first element mentioned below could be termed a second element without departing from the technical ideas of the present disclosure.

In addition, in the present specification, the term “illustrative” is used as the meaning of “used as an example or an illustration”. In the present specification, an arbitrary embodiment described to be “illustrative” should not be analyzed to be necessarily preferable or to have more advantageous than another embodiment.

In addition, the term “units” described in the specification mean units for processing at least one function and operation and may be implemented by software elements or hardware elements, such as a field programmable gate array (FPGA) or an application specific integrated circuit (ASIC). However, the “units” are not limited to software elements or hardware elements. The “units” may be embodied on an addressing recording medium and may be configured to operate one or more processors. Therefore, for example, the “units” may include elements, such as software elements, object-oriented software elements, class elements, and task elements, processes, functions, properties, procedures, subroutines, program code segments, drivers, firmware, micro codes, circuits, data, databases, data structures, tables, arrays, and variables. Elements and functions provided in the “units” may be combined to smaller numbers of elements and “units” or may be further divided into larger numbers of elements and “units.”

Also, all “units” of the disclosure may be controlled by at least one processor, and at least one processor may perform an operation performed by the “unit” of the disclosure.

Embodiments of the disclosure may be described from the viewpoint of functions or blocks performing functions. Blocks that may be referred to as “units” or “modules” of the disclosure may be physically implemented by analog or digital circuits such as logic gates, integrated circuits, microprocessors, microcontrollers, memories, passive electronic components, active electronic components, optical components, and/or hardwired circuits, and may optionally be driven by firmware and software.

Embodiments of the disclosure may be implemented by using at least one software program executed on at least one hardware device, and may perform a network management function to control elements.

Unless otherwise defined, all terms (including technical and scientific terms) used herein have the same meaning as commonly understood by those skilled in the technical field to which the present disclosure pertains. It will be further understood that terms, such as those defined in commonly used dictionaries, should not be interpreted in an idealized or overly formal sense unless expressly so defined herein.

In the present disclosure, the “public server” may include a server (or an official server) operated by an original provider providing a specific game or a server operated by a third party authorized by a public server operator.

In the present disclosure, the “private server” may be all servers except for a public server among servers operating a specific game.

In the present disclosure, the “keyword” corresponds to the possibility that a specific operating server may be a private server, and may include a word or abbreviation generally used to indicate that the website operating server is a private server.

In the present disclosure, the “first area” is an area including a HTML title and keyword areas in a meta tag.

In the present disclosure, the “second area” is all areas except a first area in a meta tag. Accordingly, the meta tag of a specific web page may be composed of the first area and the second area.

Hereinafter, embodiments of the present disclosure will be described in detail with reference to the accompanying drawings.

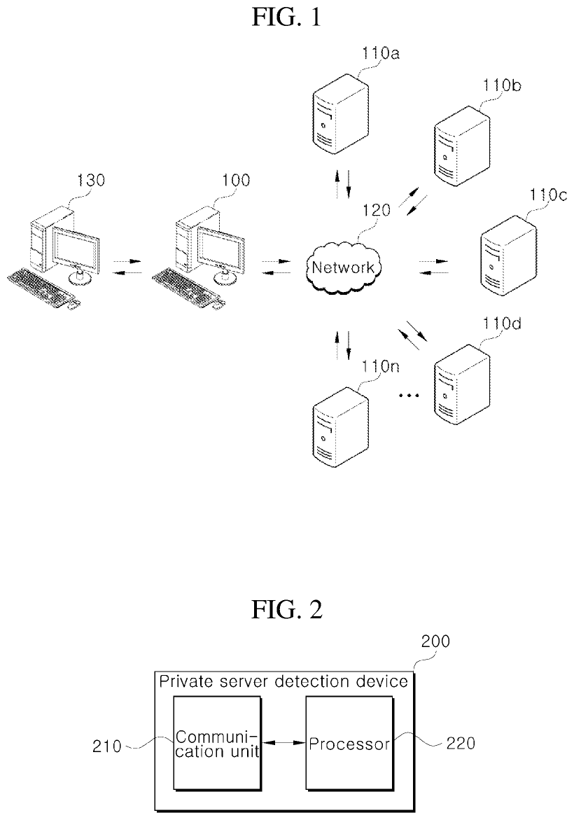

FIG. 1 is a schematic diagram for collecting banners according to an embodiment of the present disclosure.

An electronic device 100 including a computer or server may communicate with at least one server 110a, 110b, 110c, 110d, . . . 110n to detect a private server. The electronic device 100 may communicate with at least one server 110a, 110b, 110c, 110d, . . . 110n using a network 120, and the network 120 may include a wired or wireless communication link and a connection unit (not shown) such as an optical fiber cable. In addition, the network 120 may be implemented as a variety of different networks, such as an intranet, a local area network (LAN), or a wide area network (WAN).

Referring to FIG. 1, the electronic device 100 and at least one server 110a, 110b, 110c, 110d, . . . 110n are connected to the network 120. In the illustrated example, the servers 110a, 110b, 110c, 110d, . . . 110n may provide data such as a banner file of a web page, a boot file, an operating system image or application, and an IP address to the electronic device 100.

In the present disclosure, the “banner” may include a result obtained by requesting information on a web page corresponding to the specific IP address and port number from a server having a specific IP address value.

A port is an endpoint to a logical connection between the electronic device (not shown) of a user connected through the network 120 and the servers 110a, 110b, 110c, 110d, . . . 110n. Ports are typically identified by a port number. The port number ranges from 0 to 65,536. The port number is assigned by the Internet Assigned Numbers Authority (IANA). The IANA is operated by the Internet Corporation for Assigned Names and Numbers (ICANN).

Each of the servers 110a, 110b, 110c, 110d, . . . 110n has a port used and a port not used, and a certain port number is pre-allocated according to the type of application or service related to the current server. These pre-assigned or standard port numbers are called known ports (or well-known ports). The number of known port numbers designated or pre-allocated to specific services and applications is approximately 1,024. For example, the known port number is port 80 for Hypertext Transfer Protocol (HTTP) traffic, port 23 for Telnet, port 25 for Simple Mail Transfer Protocol (SMTP), port 53 for Domain Name Server (DNS), and port 194 for Internet Relay Chat (IRC), but is not limited thereto. Accordingly, any port on any server designated for the hypertext transfer protocol will typically have an assigned port number of 80.

According to an embodiment of the present disclosure, the electronic device 100 may request a banner for all port numbers of at least one server 110a, 110b, 110c, 110d, . . . 110n having a specific IP address value. At least one server 110a, 110b, 110c, 110d, . . . 110n may include a server connected to the whole world through a network. At least one server 110a, 110b, 110c, 110d, . . . 110n that has received the banner request may transmit the banner as a return value when a specific port is for a web page. Accordingly, the electronic device 100 may obtain a banner of a web page corresponding to the port number being used from at least one server 110a, 110b, 110c, 110d, . . . 110n that has received the request.

According to an embodiment of the present disclosure, the electronic device 100 may obtain a banner as a return value by requesting a banner from the global IP address and port number, and the obtained banner is stored in the memory (not shown) of the electronic device 100 in the form of a database.

Also, the database may include a banner and an IP address and port number from which the banner is transmitted. A specific banner, an IP address to which the specific banner is transmitted, and a port number may be mapped and stored. Accordingly, when a private server detection device 130 accesses a web page corresponding to a banner including a keyword, the private server detection device 130 may access the web page by checking the IP address and port number of the database.

According to an embodiment of the present disclosure, the electronic device 100 may obtain a banner through a banner request technique such as banner grabbing. The banner grabbing corresponds to a known technique, and thus a more detailed description will be omitted.

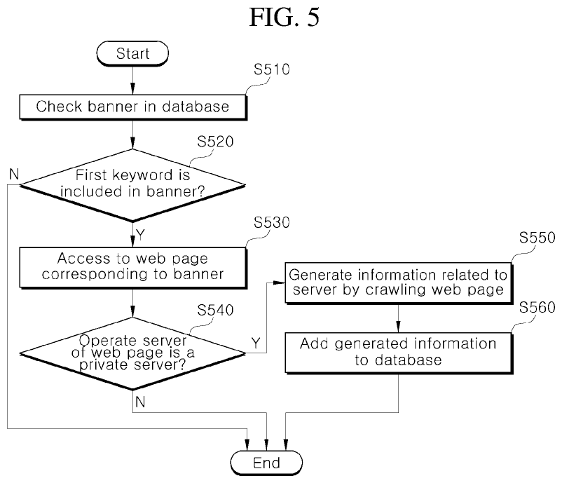

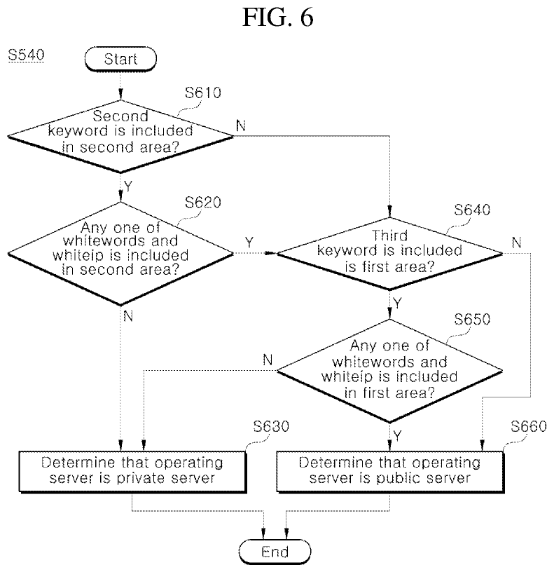

When a banner is obtained, the private server detection device 130 may determine whether a specific server is a private server, based on the obtained banner. A method for determining whether the server is a private server will be described later in detail with reference to FIGS. 5 and 6.

In the present disclosure, it has been described that the separate electronic device 100 obtains a banner, but the present disclosure is not limited thereto. Accordingly, the private server detection device 130 may directly obtain a banner for the global IP address and port number instead of receiving the banner from the electronic device 100.

FIG. 2 is a block diagram illustrating a private server detection device 200 according to an embodiment of the present disclosure. The private server detection device 200 of FIG. 2 may correspond to the private server detection device 130 of FIG. 1.

According to an embodiment of the present disclosure, the private server detection device 130 may include a communication unit 210 and a processor 220.

According to an embodiment of the present disclosure, the communication unit 210 may receive from the electronic device 100 a banner obtained (or received) from at least one server 110a, 110b, 110c, 110d, . . . 110n.

In addition, the communication unit 210 may communicate with various types of external devices according to various types of communication methods. The communication unit 210 may include at least one of a Wi-Fi chip, a Bluetooth chip, a wireless communication chip, and an NFC chip.

The Wi-Fi chip and the Bluetooth chip may communicate using a Wi-Fi method and a Bluetooth method, respectively. In the case of using a Wi-Fi chip or a Bluetooth chip, various types of connection information such as an SSID and a session key is first transmitted and received, and various types of information can be transmitted and received after communication connection using the same. The wireless communication chip may refer to a chip that performs communication according to various communication standards such as IEEE, ZigBee, 3rd Generation (3G), 3rd Generation Partnership Project (3GPP), or Long Term Evolution (LTE). The NFC chip refers to a chip operating in an NFC (Near Field Communication) method using a 13.56 MHz band among various RF-ID frequency bands such as 135 kHz, 13.56 MHz, 433 MHz, 860 to 960 MHz, and 2.45 GHz.

According to an embodiment of the present disclosure, the private server detection device 200 may further include a memory (not shown). The memory is a local storage medium that may include a database. The database may include a banner received by the communication unit 210 and data processed by the processor 220. In addition, the database may include a banner and an IP address and port number from which the banner is transmitted. Accordingly, when accessing a web page corresponding to a banner including a keyword, the private server detection device 200 may access the web page by checking the IP address and port number of the database.

The memory (not shown) of the private server detection device 200 may be provided as a writable Read Only Memory (ROM) to have data remain therein even upon cut-off of power to the private server detection device 200 and to reflect changes. In other words, the memory may be provided as one of a flash memory, an Erasable Programmable ROM (EPROM), and an Electrically Erasable Programmable ROM (EEPROM). In the present disclosure, for convenience of explanation, it is described that all instruction information is stored in one memory, but the present disclosure is not limited thereto, and the private server detection device 200 may include a plurality of memories.

According to an embodiment of the present disclosure, the processor 220 may be controlled to check a banner in the database received from the electronic device 100, determine whether a first keyword is included in the banner, access a web page corresponding to the banner through the communication unit (210) when the first keyword is included, determine whether an operating server of the web page is a private server, based on a meta tag of the web page, generate information related to the operating server by crawling the web page when the operating server is a private server, and adds the generated information to the database. The process of determining whether the operating server of the web page is a private server, based on the meta tag of the web page will be described in detail later with reference to FIGS. 5 and 6.

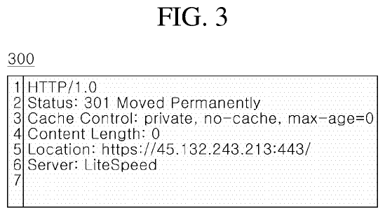

FIG. 3 is a diagram illustrating a banner 300 according to an embodiment of the present disclosure.

According to an embodiment of the present disclosure, when a target corresponding to a specific IP address and port number is a web page, the banner may display information about the web page. For example, the banner may include a communication protocol of a web page, a status of a corresponding web page, and cache control.

The private server detection device 200 may check the banner 300, and when the first keyword is included, the private server detection device may access a web page corresponding to the banner 300. Specifically, since the memory 220 stores the IP address to which the banner 300 is transmitted and the port number corresponding to the web page along with the banner 300, the private server detection device may check the IP address and port number to access a web page corresponding to the banner 300.

According to an embodiment of the present disclosure, the keyword may include a word commonly used to indicate that a private server is a private server. For example, the keyword may include at least one of a game name, an abbreviation of the game name, MMORPG, top server, pserver, priv, top, free, mmo, rpg, and private.

In addition, all of the first to third keywords of the present disclosure are included in the keywords, and the processor 220 may determine whether the operating server is a private server, based on whether the first to third keywords are included.

According to an embodiment of the present disclosure, all of the first to third keywords may be different or at least two or more may be the same.

As illustrated in FIG. 3, since the banner 300 includes the keyword private, the private server detection device 200 may access the web page in order to determine whether the operating server of the web page corresponding to the banner 300 is a private server.

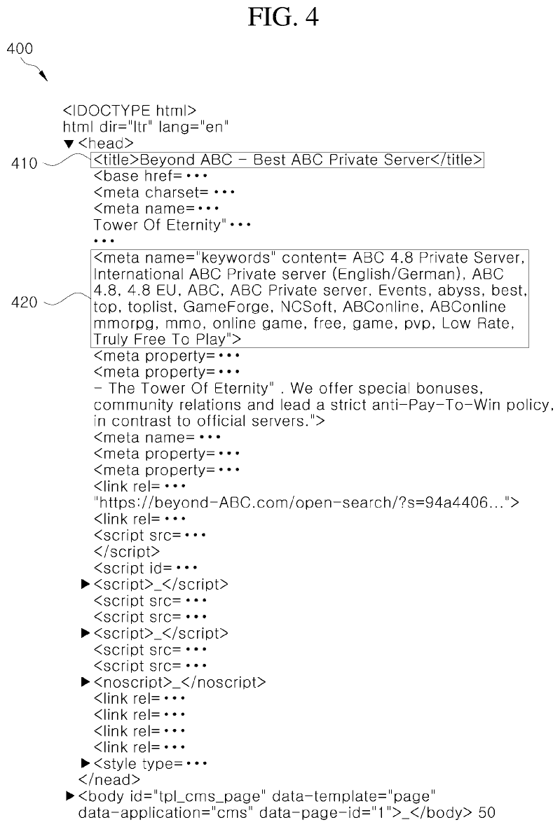

FIG. 4 is a diagram illustrating a meta tag 400 according to an embodiment of the present disclosure.

In the present disclosure, the meta tag is document information for a specific web page, and the private server detection device 200 may access a specific web page and check the meta tag of the corresponding web page. Referring to FIG. 4, the meta tag 400 may be a meta tag of a web page corresponding to the banner 300.

According to an embodiment of the present disclosure, the meta tag 400 may include a first area including a HTML title 410 and a keyword area 420 and a second area the remaining areas except for the HTML title 410 and the keyword area 420.

As illustrated in FIG. 4, the meta tag 400 is document information on a web page, and may include information on a server operating the web page. Accordingly, the private server detection device 200 may determine whether the operating server operating the web page is a private server by checking the meta tag 400.

FIG. 5 is a flowchart illustrating a method for detecting a private server according to an embodiment of the present disclosure.

Each operation of the control method of the private server detection device 200 of the present disclosure may be performed by various types of electronic devices including the communication unit 210, the memory 220, and the processor 220.

Hereinafter, a process in which the processor 220 detects a private server according to the present disclosure will be mainly described in detail with reference to FIGS. 5 and 6.

The embodiments described for the private server detection device 200 may be applicable to at least some or all of the control method of the private server detection device 200, and vice versa, the embodiments described for the control method of the private server detection device 200 may be applicable to at least some or all of the embodiments for the private server detection device 200. In addition, the control method of the private server detection device 200 according to the described embodiments is not limited to an embodiment in which the private server detection device 200 described in this description performs the method, and may be performed by various types of electronic devices.

First, the processor 220 may check a banner in the database provided by the electronic device 100 [S510].

According to an embodiment of the present disclosure, the private server detection device 200 may receive a banner from the electronic device 100 through the communication unit 210, and determine whether an operating server is a private server by checking the received banner.

The banner of the database may be obtained by requesting a banner for the global IP address and port number. When a specific banner is obtained in response to a banner request, the IP address from which the specific banner is transmitted and the port number for providing the web page may be stored in the memory (not shown) of the electronic device 100 as a database in association with the specific banner.

Next, the processor 220 may determine whether the first keyword is included in the banner [S520].

According to an embodiment of the present disclosure, the first keyword may include a word generally used by the server operator to indicate that the server that the server operator operates is a private server. For example, the first keyword may include at least one of a game name, an abbreviation of the game name, mmorpg, top server, pserver, priv, top, free, mmo, rpg, and private.

Next, when the first keyword is included in the banner, the processor 220 may access a web page corresponding to the banner [S530].

The processor 220 may access the web page corresponding to the banner including the first keyword by checking the IP address for transmitting a specific banner and the port number for providing the web page stored in the memory 210.

Next, the processor 220 may determine whether the operating server of the web page is a private server, based on the meta tag of the accessed web page [S540].

A process in which the processor 220 determines the private server will be described in detail with reference to FIG. 6.

Next, when it is determined that the operating server is a private server, the processor 220 may crawl (or scrape) the web page to generate information related to the operating server [S550].

According to an embodiment of the present disclosure, the information related to the operating server may include at least one of a hosting server operating the operating server, a host name, a country code, and a domain address.

In the present disclosure, the crawling (or web crawling, web scraping) technique may refer to a series of processes for collecting content existing on the web.

According to an embodiment of the present disclosure, the crawling technique may include i) a technique of fetching an HTML page, parsing HTML/CSS, and extracting only necessary data, ii) a technique of calling an Open API to a service providing an Open API (Rest API) and extracting only necessary data from the received data, and iii) a technique of manipulating a browser such as Selenium with programming and extracting only necessary data.

Since the crawling technique corresponds to a known technique, a detailed description thereof will be omitted.

Next, the processor 220 may add the generated information to the database [S560].

FIG. 6 is a flowchart illustrating a method for detecting a private server according to an embodiment of the present disclosure. The operation of FIG. 6 may be an example of S540 of FIG. 5.

According to an embodiment of the present disclosure, the processor 220 may determine whether the second keyword is included in the second area in order to determine whether the operating server is a private server [S610].

According to an embodiment of the present disclosure, the meta tag 400 may include a first area and a second area, and the processor 220 preferentially checks the second area to determine whether keywords are included and whether whiteIP or whitewords are included. Thus, the processor 220 can reduce the time consumed for determining whether the server is a private server even though there are a plurality of operating servers.

According to an embodiment of the present disclosure, the first keyword determined to be included in S520 and the second keyword determined to be included in S610 may not be the same. For example, in S520, the processor 220 may include the keyword private in the banner 300, but the keyword free may be included in the second area. Accordingly, the processor 220 may perform the operation of operation S620 even though the first keyword determined to be included in S520 and the second keyword determined to be included in S610 are different. In addition, as described above, the third keyword may also be different from the first keyword and the second keyword.

Next, when the second keyword is determined to be included in the second area, the processor 220 may determine whether any one of whitewords and whiteIP is included in the second area [S620].

In the present disclosure, whitewords and whiteIP indicate that the website operating server is not a private server. A server operating a web page having a meta tag including whitewords or whiteIP may be a server operated by a public server operator or a third party authorized by the public server operator.

According to an embodiment of the present disclosure, the operating server of the whitewords web page may include a public server or a server operated by a third party authorized by the public server operator. In addition, whiteIP may include the IP address of a public server or a server operated by a third party authorized by the public server operator.

According to an embodiment of the present disclosure, the whitewords of the AION (registered trademark) game may include ai one, tropaion, and powerlogic.

Next, when both whitewords and whiteIP are not included in the second area, the processor 220 may determine that the operating server of the corresponding web page is a private server [S630].

According to an embodiment of the present disclosure, when it is determined in S610 that the second keyword is not included in the second area, the processor 220 may determine whether the third keyword is included in the first area [S640].

As described above, the third keyword may also be the same as or different from the first keyword and the second keyword. For example, in S520, the processor 220 may include the keyword private in the banner 300, but the keyword free may be included in the first area.

According to another embodiment of the present disclosure, even when it is determined in S620 that any one of whitewords and whiteIP is included in the second area, the processor 220 may determine whether the third keyword is included in the first area [S640].

Even though the second keyword is included in the second area, it is determined again whether the third keyword is included in the first area because there is a possibility that the operating server may be a private server even though whitewords or whiteIP is included in another area in the meta tag.

Next, when the third keyword is included in the first area, the processor 220 may determine whether any one of whitewords and whitetip is included in the first area [S650].

According to an embodiment of the present disclosure, when any one of whitewords and whitetip is included in the first area, the processor 220 may determine that the operating server of the accessed web page is a public server [S650].

In addition, even when the third keyword is not included in the first area in S640, the processor 220 may determine that the operating server of the accessed web page is a public server [S650].

Conversely, when both whitewords and whitetip are not included in the first area, the processor 220 may determine that the operating server of the accessed web page is a private server [S630].

Various embodiments of the present disclosure may be implemented by software including one or more instructions stored in a storage medium (for example, a memory) readable by a machine (for example, a private server detection device 200 or a computer). For example, the processor (for example, the processor 220) of a machine may call at least one instruction among one or more instructions stored in a storage medium and execute the instructions thus called. This means that the machine may perform at least one function based on the called at least one instruction. The one or more instructions may include a code generated by a compiler or executable by an interpreter. The machine-readable storage medium may be provided in the form of non-transitory storage medium. Here, the term “non-transitory storage medium”, as used herein, means that the storage medium is tangible, but does not include a signal (e.g., an electromagnetic wave). This term does not differentiate a case where the data is semi-permanently stored in the storage medium from a case where the data is temporally stored in the storage medium. For example, the term non-transitory storage medium” may include a buffer in which data is temporarily stored.

According to an embodiment, the method according to various embodiments described in the present disclosure may be included in and provided as a computer program product. The computer program product may be traded between a seller and a buyer as a product. The computer program product may be distributed in the form of machine-readable storage medium (for example, a compact disc read only memory (CD-ROM)) or may be directly distributed (for example, download or upload) online through an application store (for example, a Play Store™) or between two user devices (for example, the smartphones). In the case of online distribution, at least a portion of the computer program product (for example, an downloadable app) may be temporarily stored or generated in a machine-readable storage medium such as a memory of a manufacturer's server, an application store's server, or a relay server.

Hereinbefore, the present disclosure has been described with reference to the embodiments shown in the accompanying drawings. It will be understood by those skilled in the technical field to which the present disclosure pertains that the present disclosure may be embodied in various other specific forms without departing from the technical ideas or essential characteristics of the present disclosure. Therefore, the disclosed embodiments should be considered in an illustrative rather than a restrictive perspective in all aspects.

1. A private server detection method through a computer, the method comprising:
checking a banner in a database;
determining whether a first keyword is included in the banner;
accessing a web page corresponding to the banner when the first keyword is included;
determining whether an operating server of the web page is a private server, based on a meta tag of the web page;
generating information related to the operating server by crawling the web page when the operating server is a private server; and
adding the generated information to the database,
wherein the web page corresponds to an IP address and port number from which the banner is obtained.

2. The method of claim 1, wherein the determination of whether the operation sever is a private server comprises:
determining whether a second keyword is included in a second area, other than a first area, including a HTML title and a keyword area in the meta tag;
determining whether a third keyword is included in the first area when the second keyword is not included;
determining whether the third keyword is included in the first area when the second keyword is included and any one of whitewords and whiteIP is included in the second area; and
determining that the operating server is a private server when the second keyword is included and neither whitewords nor whiteIP is included in the second area.

3. The method of claim 1, wherein the determination of whether the third keyword is included in the first area comprises:
determining that the operating server is a public server when the third keyword is not included in the first area; and
determining that the operating server is a public server only when the third keyword is included in the first area and any one of the whitewords and whiteIP is included in the first area.

4. The method of claim 1, wherein the banner is obtained by requesting the banner from a global IP address and port number.

5. The method of claim 1, wherein the information related to the operating server comprises at least one of a hosting server operating the operating server, a host name, a country code, and a domain address.

6. A private server detection device, comprising:
a communication unit;
a memory with a database; and
a processor configured to:
check a banner in the database;
determine whether a first keyword is included in the banner;
access a web page corresponding to the banner through the communication unit when the first keyword is included;
determine whether an operating server of the web page is a private server, based on a meta tag of the web page;
generate information related to the operating server by crawling the web page when the operating server is a private server; and
add the generated information to the database,
wherein the web page corresponds to an IP address and a port number from which the banner is obtained.

7. The device of claim 6, wherein the processor is configured to determine whether the operating server is a private server by:
determining whether a second keyword is included in a second area, other than a first area, including a HTML title and a keyword area in the meta tag;
determining whether a third keyword is included in the first area when the second keyword is not included;
determining whether the third keyword is included in the first area when the second keyword is included and any one of whitewords and whiteIP is included in the second area; and
determining that the operating server is a private server when the second keyword is included and neither whitewords nor whiteIP is included in the second area.

8. The device of claim 7, wherein the processor is configured to determine whether the third keyword is included in the first area by:
determining that the operating server is a public server when the third keyword is not included in the first area; and
determining that the operating server is a public server only when the third keyword is included in the first area and any one of the whitewords and whiteIP is included in the first area.

9. The device of claim 6, wherein the information related to the operating server comprises at least one of a hosting server operating the operating server, a host name, a country code, and a domain address.

10. A computer program being combined with a computer and being stored in a computer-readable storage medium to execute the private server detection method of claim 1.
